(19) United States
(12) Patent Application Publication
(10) Pub. No.: US 2023/0135196 A1
(43) Pub. Date: May 4, 2023

(54) IN-MEETING FOLLOW-UP SCHEDULERS FOR VIDEO CONFERENCES

(71) Applicant: Zoom Video Communications, Inc., San Jose, CA (US)

(72) Inventor: Randy OH, Dublin, CA (US)

(73) Assignee: Zoom Video Communications, Inc., San Jose, CA (US)

(21) Appl. No.: 17/514,922

(22) Filed: Oct. 29, 2021

(51) Int. Cl. H04L 29/06; G06F 3/0482

(52) U.S. Cl. CPC H04L 65/1069; G06F 3/0482; H04L 65/403

(57) ABSTRACT

One method for in-meeting follow-up schedulers for video conferences includes joining, by a client device using a video conferencing application, a video conference hosted by a video conference provider; receiving, by the video conferencing application, a selection of a subset of participants in the video conference; receiving, by the video conferencing application, meeting information associated with a follow-up video conference; generating, by the video conferencing application, a meeting invitation to each participant of the subset of participants based on the received meeting information; scheduling, by the video conferencing application, the follow-up video conference with the video conference provider; and providing, by the video conferencing application, the meeting invitation to each participant of the subset of participants.

### FIELD

The present application generally relates to video conferences and more particularly relates to in-meeting follow-up schedulers for video conferences.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for in-meeting follow-up schedulers for video conferences;

FIGS. 3A-3B show an example system for in-meeting follow-up schedulers for video conferences;

FIGS. 4-13 show example graphical user interfaces (“GUIs”) for in-meeting follow-up schedulers for video conferences;

FIG. 14 shows an example method for in-meeting follow-up schedulers for video conferences; and

FIG. 15 shows an example computing device suitable for use with example systems and methods for in-meeting follow-up schedulers for video conferences.

### DETAILED DESCRIPTION

Examples are described herein in the context of in-meeting follow-up schedulers for video conferences. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

People participate in video conferences for a wide variety of reasons, such as to keep in touch with family, conduct business, or manage groups or organizations. To participate in a video conference, each participant uses a software client, which may be a discrete application natively running on the participant's client device or it may be an application executed within a separate environment on the client device, such as in a web browser. The software client accesses the client device's microphone and camera to capture audio and video to enable the user to participate in the video conference. In addition, the software client provides a graphical user interface (“GUI”) that includes visual displays of some or all of the participants in the video conference. The software client also outputs audio received from the various participants via speakers or headphones.

In some cases, participants in a video conference may want to schedule follow-up meetings to discuss topics raised during a video conference. Conventionally, people keep track of such actions by taking notes about action items to address after the meeting or by multitasking and manually performing other actions, such as launching a calendar application. Because these actions are taken manually and may rely on the diligence of individual participants, or may distract the participant from the meeting itself, follow-up items can be forgotten or delayed.

An example software client according to this disclosure receives audio and video from its user and provides that data to the video conference provider to distribute to the other participants, and the user's software client receives such streams from the other participants, which display some or all of the displayed streams in the GUI. If a participant determines that a follow-up meeting is needed, they can schedule the meeting directly within the software client by selecting one or more participants to be included in the follow-up meeting, activating an option to schedule a follow-up meeting, such as by selecting a button or opening a context-sensitive menu and selecting an option to schedule a follow-up meeting.

To facilitate the scheduling process, the software client may access electronic calendars for one or more of the selected participants, or may send requests to the other participants, to identify potential times for a follow-up meeting. The user may then select an available time and schedule the meeting. As a part of scheduling the meeting, the software client may communicate with the video conference provider to create a new scheduled meeting, and obtain information about that meeting, such as a meeting identifier and passcode. If the software client has access to another participant's electronic calendar, it can then add the new meeting to the calendar, including some or all of the meeting information obtained from the video conference provider, or it can send a notification to the other participant(s) about the new meeting. This may include generating and sending a link, e.g., a Uniform Resource Locator (“URL”), or file to the other participants, such as in a chat window. The participant(s) can click the URL (or open the file) to access a meeting invitation, which they can then add to their calendar.

Because this functionality can occur while the original video conference is on-going, the participants are able to both decide that a follow-up is needed and schedule that meeting without either accessing another application and manually creating a new meeting, or taking notes and remembering after the video conference ends to schedule the follow-up meeting. Incorporating the scheduling functionality into the software client, which interacts with the video conference provider, the other participants software clients, and one or more electronic calendar, enables a seamless ability to schedule new video conferences.

This illustrative example is given to introduce the reader to the general subject matter discussed herein and the disclosure is not limited to this example. The following sections describe various additional non-limiting examples and examples of in-meeting follow-up schedulers for video conferences.

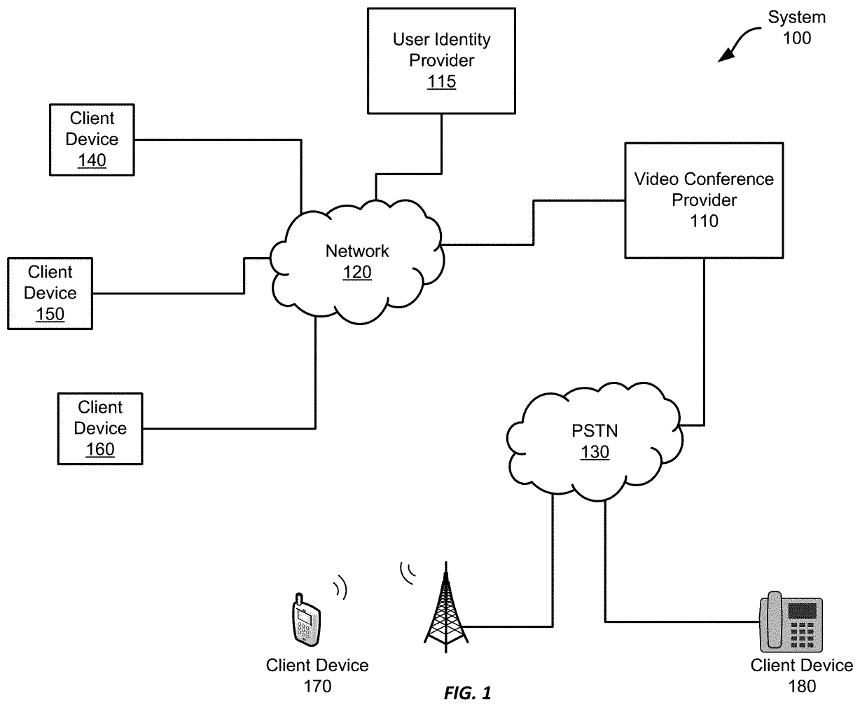

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 120 can be located within a private network to provide video conferencing services to devices within the private network, or it can be connected to a public network, e.g., the internet, so it may be accessed by anyone. Some examples may even provide a hybrid model in which a video conference provider 120 may supply components to enable a private organization to host private internal video conferences or to connect its system to the video conference provider 120 over a public network.

The system optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity.

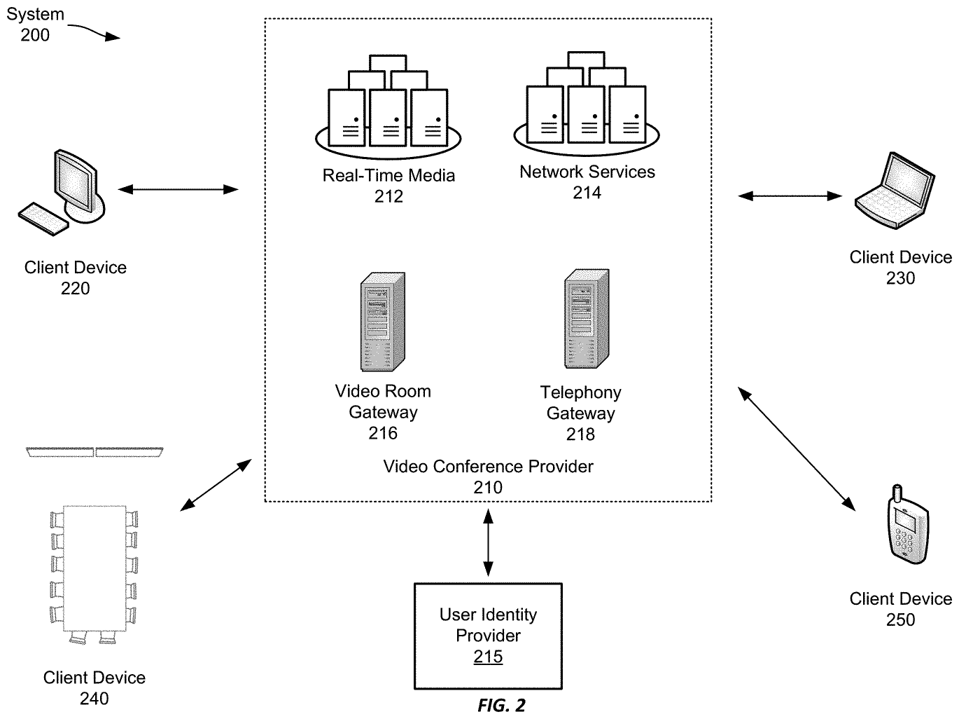

Video conference provider 110 allows clients to create videoconference meetings (or “meetings”) and invite others to participate in those meetings as well as perform other related functionality, such as recording the meetings, generating transcripts from meeting audio, manage user functionality in the meetings, enable text messaging during the meetings, create and manage breakout rooms from the main meeting, etc. FIG. 2, described below, provides a more detailed description of the architecture and functionality of the video conference provider 110.

Meetings in this example video conference provider 110 are provided in virtual “rooms” to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used. Further, in some examples, and as alluded to above, a meeting may also have “breakout” rooms. Such breakout rooms may also be rooms that are associated with a “main” videoconference room. Thus, participants in the main videoconference room may exit the room into a breakout room, e.g., to discuss a particular topic, before returning to the main room. The breakout rooms in this example are discrete meetings that are associated with the meeting in the main room. However, to join a breakout room, a participant must first enter the main room. A room may have any number of associated breakout rooms according to various examples.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating the that meeting has not yet started or the host may be required to specifically admit one or more of the users.

During the meeting, the participants may employ their client devices 140-180 to capture audio or video information and stream that information to the video conference provider 110. They also receive audio or video information from the video conference provider 210, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The video conference provider 110 may also invalidate the meeting information, such as the meeting identifier or password/passcode.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 110 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs multiple different servers (or groups of servers) to provide different aspects of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed streams to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio streams when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference system 210. In some such examples, the real-time media servers 212 may decrypt incoming multimedia streams, multiplex the multimedia streams appropriately for the various clients, and encrypt the multiplexed streams for transmission.

In some examples, to provide multiplexed streams, the video conference provider 210 may receive multimedia streams from the various participants and publish those streams to the various participants to subscribe to and receive. Thus, the video conference provider 210 notifies a client device, e.g., client device 220, about various multimedia streams available from the other client devices 230-250, and the client device 220 can select which multimedia stream(s) to subscribe to and receive. In some examples, the video conference provider 210 may provide to each client device the available streams from the other client devices, but from the respective client device itself, though in other examples it may provide all available streams to all available client devices. Using such a multiplexing technique, the video conference provider 210 may enable multiple different streams of varying quality, thereby allowing client devices to change streams in real-time as needed, e.g., based on network bandwidth, latency, etc.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the client device 214 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, creating sub-meetings or “break-out” rooms, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to create a break-out room for one or more meeting participants to join, such a command may also be handled by a network services server 214, which may create a new meeting record corresponding to the break-out room and then connect one or more meeting participants to the break-out room similarly to how it originally admitted the participants to the meeting itself.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider 210 when it is first installed and the video room gateway servers 216 may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

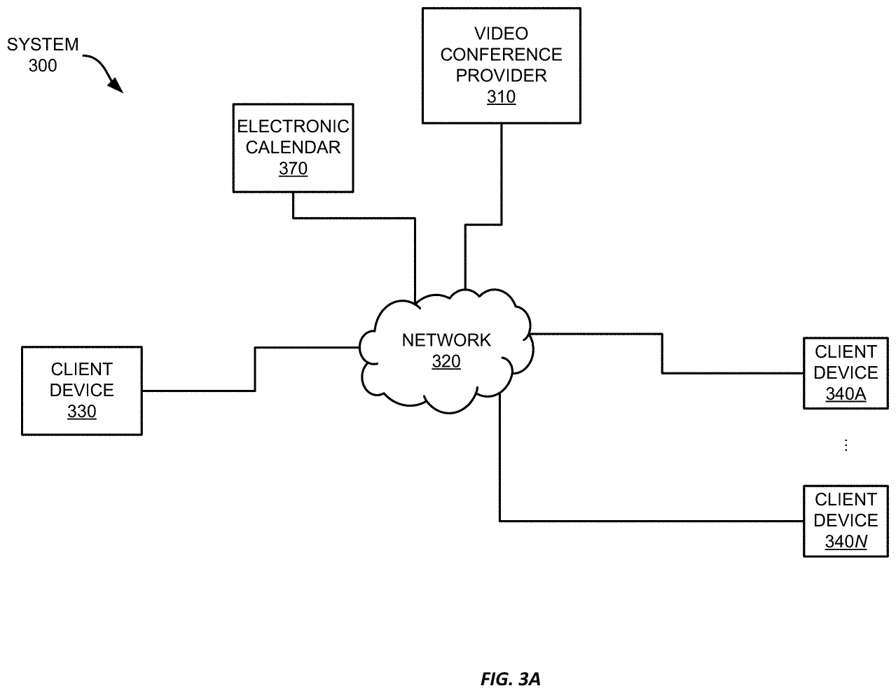

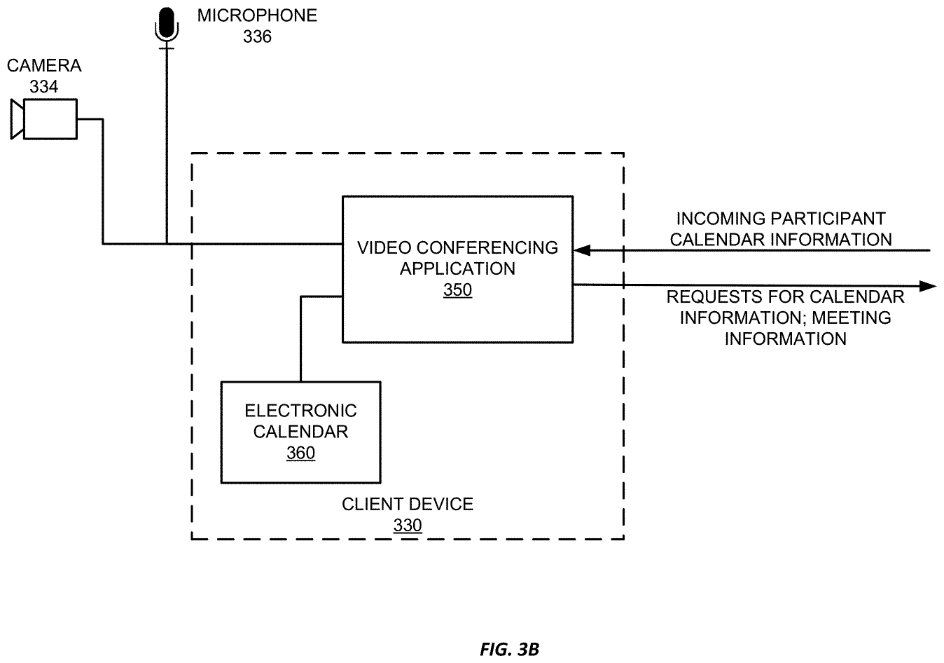

Referring now to FIG. 3A, FIG. 3A shows an example system 300 for in-meeting follow-up schedulers for video conferences. In this example system 300, a number of client devices 330, 340a-n are connected to a video conference provider 310 via a communications network 320. In addition, one or more electronic calendar providers 370 may be connected to the network 320 to enable various client devices 330, 340a-n to access electronic calendars for their respective users. In this example, the communications network 320 is the internet, however, any suitable communications network or combination of communications network may be employed, including LANs (e.g., within a corporate private LAN), WANs, etc.

Each client device 330, 340a-n executes video conference software, which connects to the video conference provider 310 and joins a meeting. During the meeting, the various participants (using video conference software at their respective client devices 330, 340a-n) are able to interact with each other to conduct the meeting, such as by viewing video streams and hearing audio streams from other participants, and by capturing and transmitting video and audio of themselves.

During the meeting, the user of client device 330 decides to schedule a follow-up meeting with some of the participants in the video conference. To do so, they interact with the GUI for their video conferencing software client (“video conferencing application” or “software client”) and select one or more of the meeting participants to identify them for a follow-up meeting. They can then select an option to schedule a follow-up meeting, and provide the meeting to each of the selected participants.

Referring now to FIG. 3B, FIG. 3B shows a more detailed view of the user's client device 330. In this example, the client device 330 has a camera 334 and a microphone 336 to allow the user to provide audio and video streams to the video conference. In addition, the client device 330 executes a video conferencing application 350 to allow the user to join and participate in video conferences hosted by the video conference provider 310, generally as discussed above.

The video conferencing application 350 has access to the user's own electronic calendar 360, such as by using an application programming interface (“API”) or other messaging mechanism. In addition, the video conferencing application 350 is able to request calendar information from other meeting participants, and provide meeting information to the other meeting participants or the video conference provider 310 to schedule a new meeting. It also can receive calendar information from the other participants, such as by accessing their electronic calendars directly, such as by accessing a corporate email or calendar application, obtaining information from the participants through manual input of free blocks of time, or by communicating with a third party electronic calendar provider 330.

The following figures provide depictions of GUIs for the video conferencing application to enable a user to perform in-meeting follow-up scheduling using the video conferencing application 350.

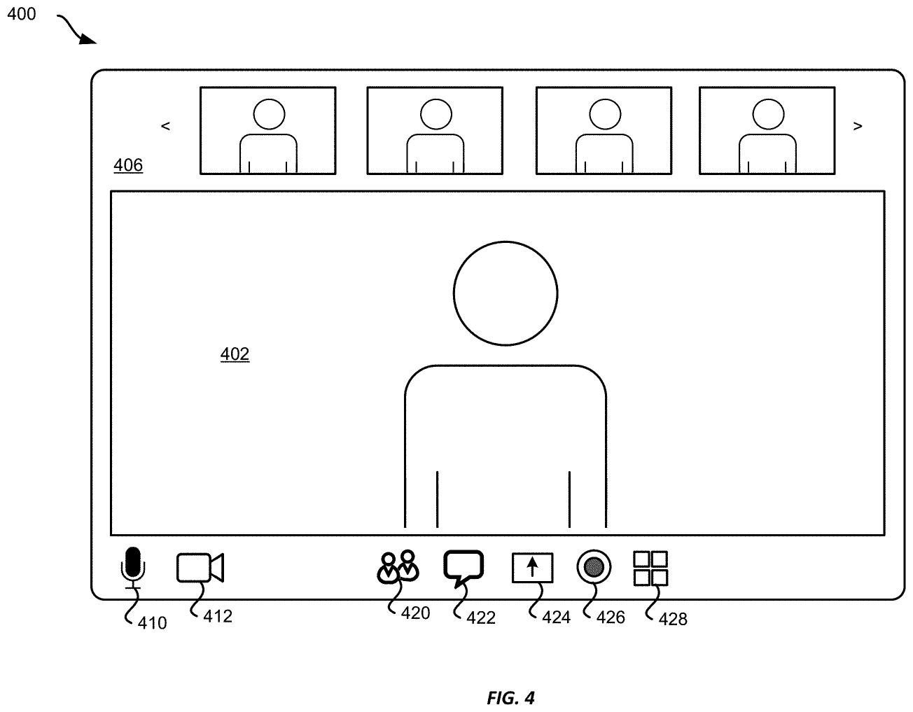

Referring now to FIG. 4, FIG. 4 shows an example default GUI 400 presented to participants in a video conference. A client device, e.g., client device 330 or client devices 340a-n, executes video conferencing software, which in turn displays the GUI 400 on the client device's display. In this example, the GUI 400 includes a speaker view window 402 that presents the current speaker in the video conference. Above the speaker view window 402 are smaller participant windows 404, which allow the participant to view some of the other participants in the video conference, as well as controls (“<” and “>”) to let the host scroll to view other participants in the video conference.

Beneath the speaker view window 402 are a number of interactive elements 410-428 to allow the participant to interact with the video conference software. Controls 410-412 may allow the participant to toggle on or off audio or video streams captured by a microphone or camera connected to the client device. Control 420 allows the participant to view any other participants in the video conference with the participant, while control 422 allows the participant to send text messages to other participants, whether to specific participants or to the entire meeting. Control 424 allows the participant to share content from their client device. Control 426 allows the participant toggle recording of the meeting, and control 428 allows the user to select an option to join a breakout room.

During the normal course of a video conference, the user interacts with the video conferencing application 350 and other participants via the GUI 400. To take advantage of the built-in in-meeting follow-up scheduling capabilities, the user may select options available via the GUI 400.

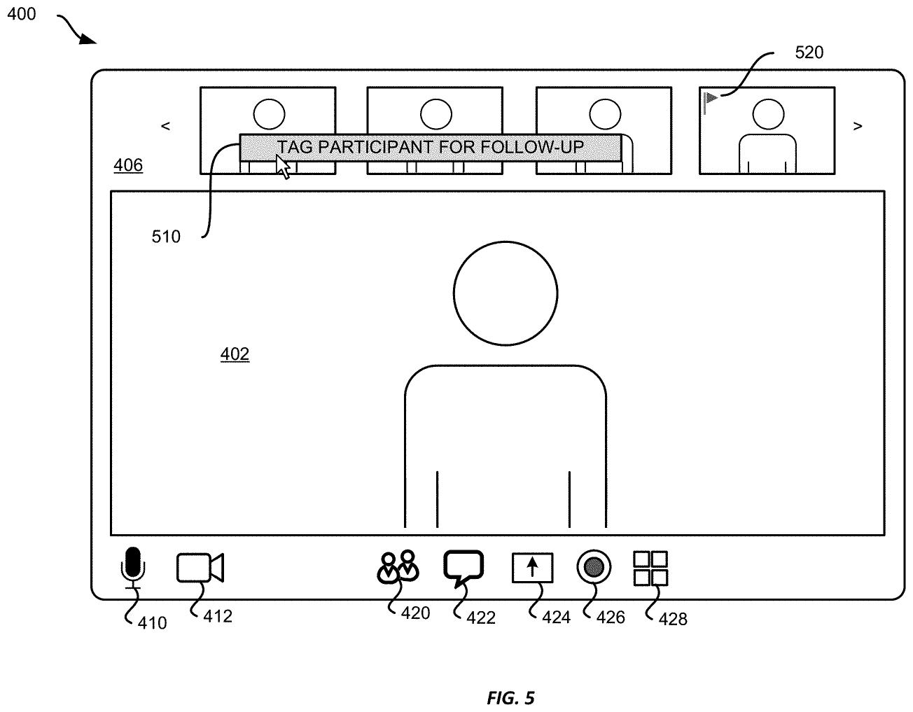

Referring now to FIG. 5, FIG. 5 shows the GUI 400 of FIG. 4 and various options available to the user to schedule follow-up meetings. In this example, the user has opened a context-sensitive menu 510 by right-clicking on another participant's video stream, though any suitable input may be used, e.g., a long press on a touch-sensitive input device. The context-sensitive menu 510 provides the user with an option to tag participants for follow-up to provide a low-impact interface to enable easy follow-up scheduling.

When the user selects the option from the menu, the video conferencing application 350 receives the selection and takes corresponding action. In this case, the user has selected the option to tag the participant for follow-up, and the video conferencing application 350 stores a record of the participant as a target for later follow-up. In addition, the video conferencing application 350 provides a visual indicator 520, e.g., the flag icon, on the video streams of users that have been selected for follow-up. In this example, only the user's GUI 400 provides the visual indicator 520; the GUIs at the respective selected participants do not indicate to the user that they have been selected. However, in some examples, the selected participants' client devices may be provided a notification that they have been selected for follow-up and may provide a visual indicator to the respective participant.

It should be appreciated that while this example involves the use of a menu, other examples may allow a user to click on one or more user's video streams 406 to select them for a follow-up meeting, or they may be able to click a check-box option in one or more participant's video streams 406. Such approaches may provide other low-impact approaches for the user to tag users for a follow-up meeting.

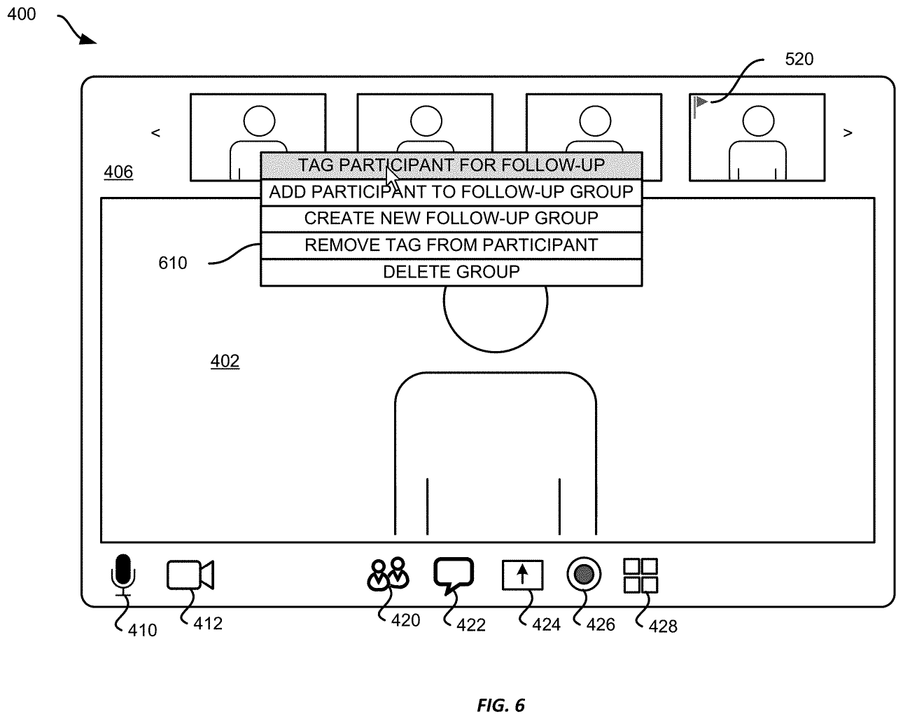

Referring now to FIG. 6, FIG. 6 shows the GUI 400 of FIG. 4 and various options available to the user to schedule follow-up meetings. In this example, the user has opened a context-sensitive menu 610 by right-clicking on another participant's video stream, similar to the menu 510 shown in FIG. 5. However, this context-sensitive menu 610 provides the user with multiple options for the selected participant: tag the selected participant for follow-up, add the participant to a follow-up group (follow-up groups are discussed in more detail below), create a new follow-up group with the participant, remove the follow-up tag from the participant, and delete the follow-up group(s) that the participant is a member of.

As discussed above, the visual indicator 520 is a flag, but any suitable indicator may be used. For example, if multiple follow-up groups are created, the user may select an icon or identifier for each group, which may then be displayed over the corresponding participants' video streams. In examples where a participant is a member of multiple follow-up groups, multiple indicators may be displayed, or the user may be able to interact with the indicator to determine which follow-up groups the participant is a member of.

In addition to tagging a participant for follow-up, the user can use follow-up groups, if multiple different follow-ups are needed. In examples where multiple groups are not required, a single group may still be used, though it may be transparent to the user that a group has been created.

A group provides a logical grouping of participants for purposes of scheduling a follow-up meeting. For example, a team meeting may include team members that are working on different aspects of a project. Thus, the team leader may, during a full-team meeting, setup follow-up meetings with different subsets of the team to discuss issues that came up during the full-team meeting, but that are specific to each subset. Thus, rather than simply tagging a participant for follow-up, the user, e.g., the team leader, can select the option to create a new follow-up group.

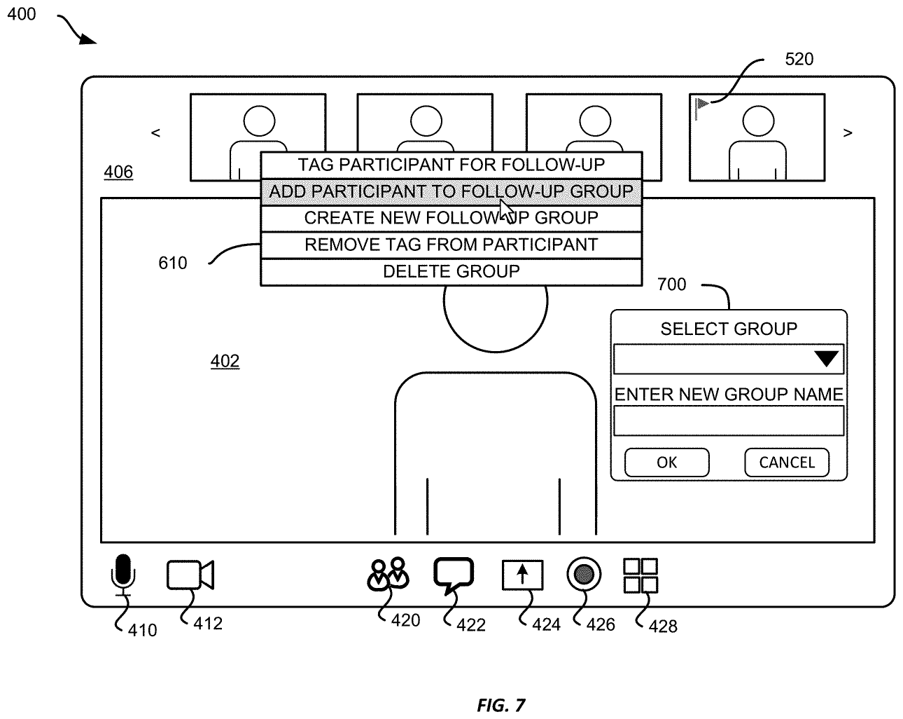

Referring now to FIG. 7, FIG. 7 shows the GUI 400 from FIGS. 4 and 5, but in this example, the user has selected the option to add the participant to a new follow-up group. In response, the GUI 400 presents the user with a request 700 to either select an existing group or to provide a name for the new group. In some examples, the GUI 400 may assign a default name, e.g., “Group 1,” instead of requesting a group name from the user. In such an example the user may have the option to later re-name the group(s).

After the user has either selected an existing group or entered the group name, the participant will be added to the respective group and an indicator will be applied to the participant's video stream. And while this example shows the user selecting the “Add Participant to Follow-Up Group” option, it will provide a similar request 700 in response to the user selecting the “Create New Follow-Up Group” option; however, the participant may not be automatically added to the new group. Instead, the user may then need to select the “Add Participant to Follow-Up Group” option to add the user to the newly created group.

Similarly, if the user determines that a participant is no longer needed for follow-up, they can select the “Remove Tag from Participant” option. If the participant is only in one follow-up group, they are removed from that group and the indicator is no longer displayed over their video stream. However, if the participant is a member of multiple follow-up groups, the user may be presented with an option, similar to request 700, where the user is requested to select which group(s) to remove the participant from.

After creating one or more follow-up groups, the user may view the existing follow-up groups and interact with the groups to perform additional functionality, such as requesting participants' availability and scheduling a follow-up meeting.

It should be appreciated that the user may add tagged users to one or more groups at any time, including as the meeting is ending or shortly after the meeting ends, but before exiting the software application. This may allow the user to remain engaged with the meeting while tagging users, and then later they can focus on grouping the participants appropriately before scheduling one or more follow-up meetings.

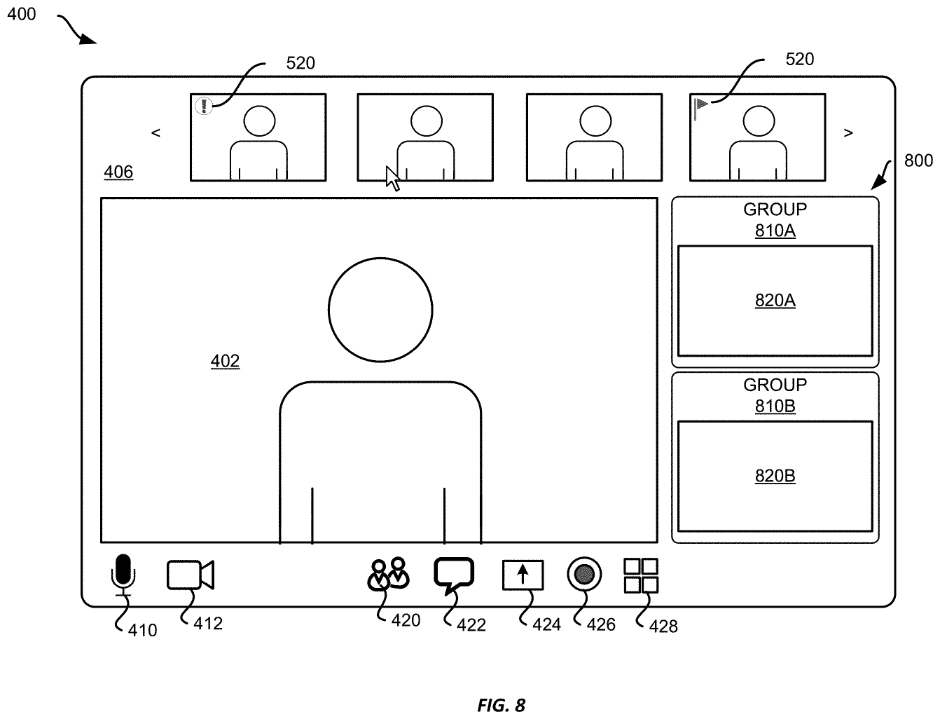

Referring now to FIG. 8, FIG. 8 illustrates a view of the GUI 400 that provides the user with information about follow-up groups. As is shown in FIG. 8, the speaker window 402 has been resized to accommodate a group display area 800. Within the group display area 800, two different groups 810a-b are shown. Each group 810a-b includes a participant list 820a-b to enable the user to view the current follow-up groups and their respective members. As discussed above, the participants in each group need not be mutually exclusive, which may allow the user to add one or more participants to multiple groups, each of which may be scheduled independently for follow-up independently of each other. Thus, the group display area 800 may allow the user to review the existing groups and the participants in each group. They may also continue to interact with the GUI 400 to create new groups, add participants to groups, etc.

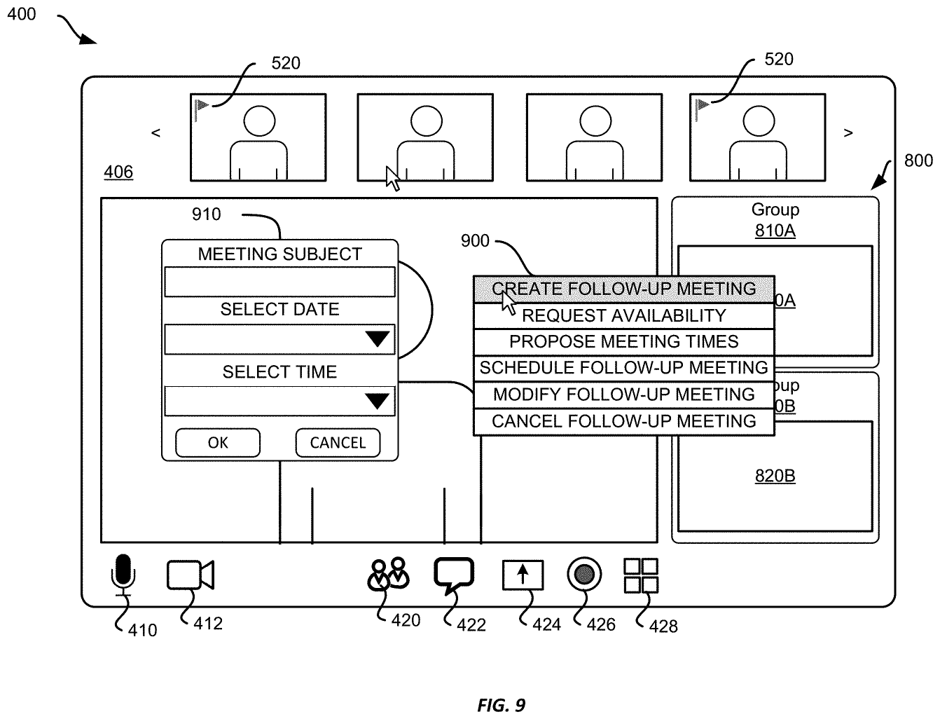

Referring now to FIG. 9, FIG. 9 illustrates the user accessing another context-sensitive menu 900, which provides functionality regarding scheduling a follow-up meeting. The options in this menu 900 include the option to create a follow-up meeting, request availability from one or more participants, to schedule the follow-up meeting, and to cancel a follow-up meeting. And while the context-sensitive menu 900 in this example is accessed in the context of one group of multiple groups, such a menu may be used in examples where only a single group is available.

The user in this example has selected the “Create Follow-Up Meeting” option, which opens a window 910 into which the user can enter information about the follow-up meeting to be created. Once the user has entered the meeting information, they can select the “Schedule Follow-Up Meeting” option to send the meeting details to the corresponding participants and to schedule the meeting at the video conference provider 310. Thus, creating the follow-up meeting in this case establishes the meeting parameters, which may be updated based on participants' availability or other needs, before the meeting is actually scheduled by adding it to the participants' calendars and notifying the video conference provider 310.

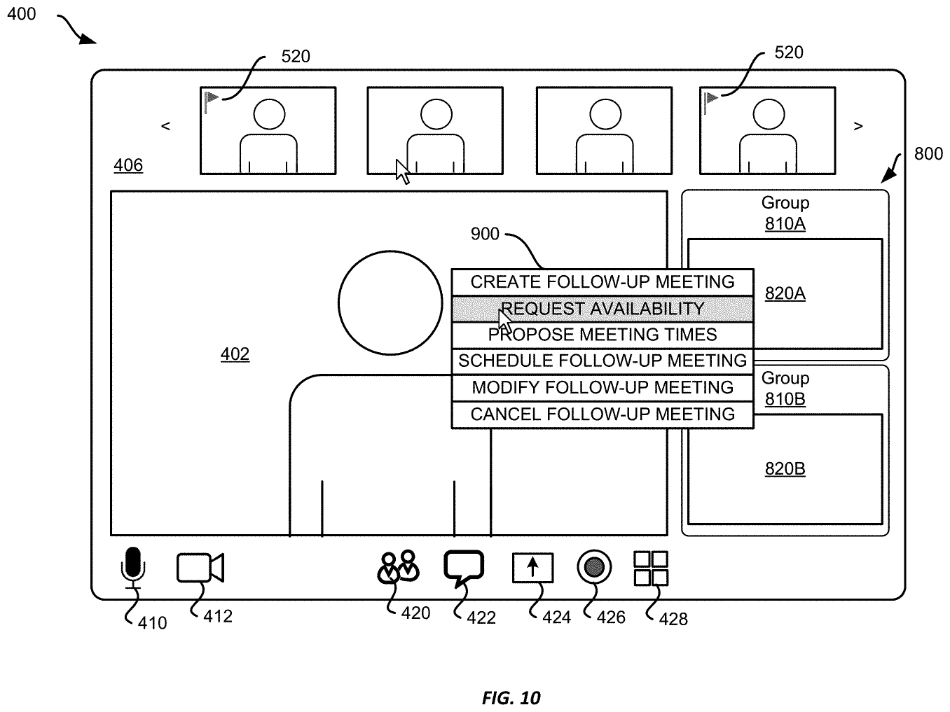

Referring now to FIG. 10, in addition to creating and scheduling a follow-up meeting, the user may also request availability from the various participants. To obtain the other participants' availability, the video conferencing application 350 may access electronic calendars for one or more of the other participants and retrieve calendar information for each it is able to access. For example, if an organization provides an electronic calendar service for its employees or members, it may allow its employees or members to access other persons' calendars to view when they are busy and when they are free. Similarly, other electronic calendar providers may allow their customers or users to publicize their calendars to varying degrees to allow other people to view their availability. The video conferencing application 350 may use such publicized calendar information to obtain availability for some or all of the participants in a particular group.

If one or more participants have not publicized their calendars, or they are not otherwise accessible to the video conferencing application 350, it may instead send a request to such participants and request they provide access to their electronic calendars or that they provide one or more times when they are available for a follow-up meeting. The participants may then either authorize access to their electronic calendars, or may provide their respective availability.

In some examples rather than simply requesting availability, the user may select the option to propose one or more times for a follow-up meeting, which may be provided to the other participants. The other participants may then select one or more time slots, which are provided to the user, who can then select a time slot for the meeting.

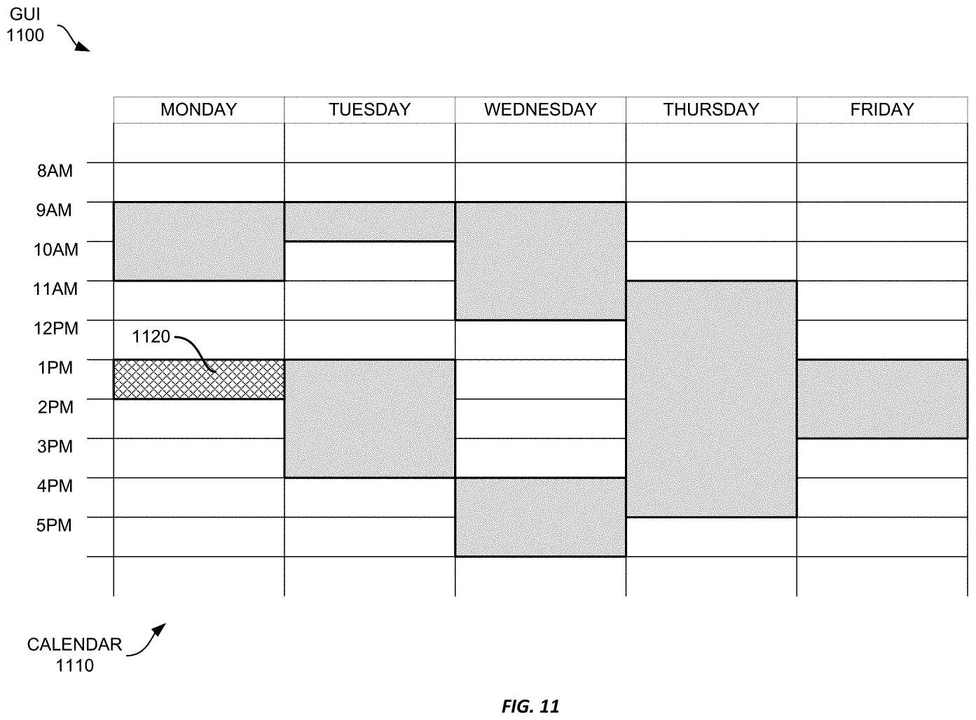

FIG. 11 shows an example GUI 1100 illustrating a graphical representation of participant availability in a calendar 1110. After selecting the option to request participant availability, as shown in FIG. 10, the video conferencing application 350 has received the various participants' calendar information and has constructed the calendar 1110 to allow the user to easily identify free blocks of time for the follow-up meeting. Each shaded block represents a time when at least one participant is not available, which allows the user to easily select a time block 1120 for the follow-up meeting. In addition, the user, in some examples may select multiple time blocks as proposed times for the meeting, which may be employed where the user does not receive availability for some or all of the other participants. After selecting the time block, the user may then propose the time(s) to the other participants, or they may schedule the meeting. If the user proposes times to the other participants, they may receive selections of one or more of the proposed time blocks, at which time the user may view the selections in the calendar GUI 1100 and select one to schedule the meeting.

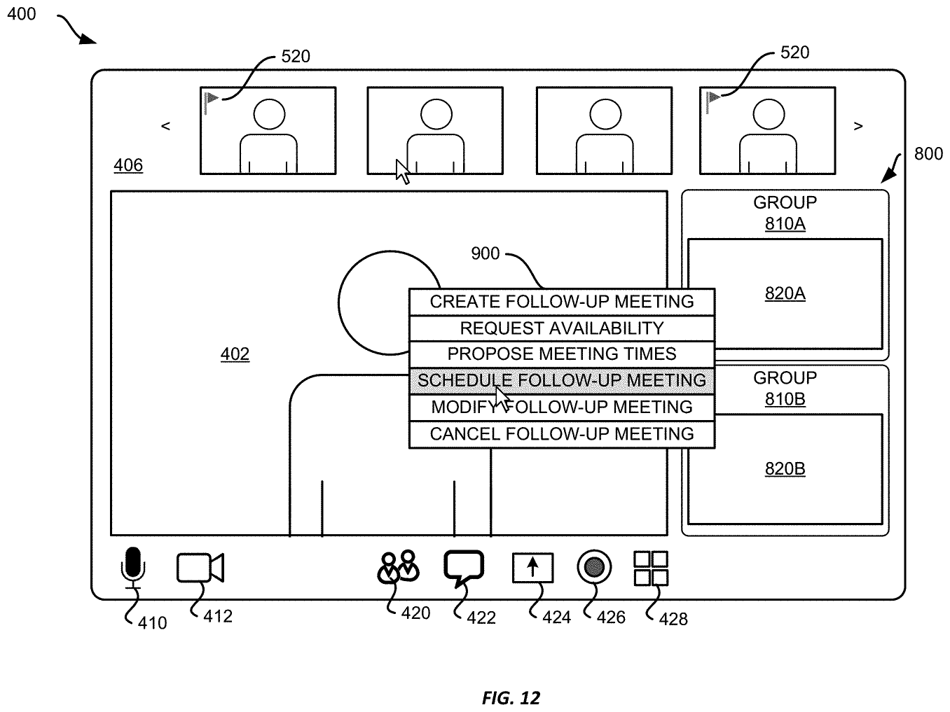

FIG. 12 illustrates the user scheduling the meeting by selecting the option to “Schedule Follow-Up Meeting.” In response, the video conferencing application communicates with the video conference provider 310 to schedule the meeting and obtain video conference information, such as a meeting identifier and passcode. It also generates a meeting invitation for each participant in the selected group based on the selected meeting time the video conference information, and provides that meeting invitation to each participant.

The functionality depicted in FIG. 12 may occur at any time during or after the meeting within the video conferencing application 350. For example, when the user selects an option to end or leave the meeting, they may be presented with the option to schedule the follow-up meeting and a listing of participants, e.g., as shown in groups 1110a-b, in the one or more groups established during the meeting, or the option to include participants in different groups, such as described above with respect to FIG. 11. Thus, the user may wait until the end of the meeting, or after the meeting, to group the participants and perform the scheduling, rather than attempting to do so while trying to stay engaged with discussions occurring during the meeting.

In addition, if the user has another meeting immediately following the current meeting, they may not immediately select the option to schedule the follow-up meeting. Instead, they may join the next meeting. If the video conferencing application 350 determines that a threshold period of time has elapsed and the user has not scheduled the follow-up meeting, it may generate a follow-up communication to the user, such as an email, a text or chat message, etc. to remind the user to schedule the follow-up meeting. The user may then return to the video conferencing application 350 to select the option to schedule the follow-up meeting.

In some examples, a relationship may be established between the follow-up meeting and the on-going video conference, such as by providing a link to the prior meeting or by providing information to enable access to a meeting recording for the on-video conference. In addition, the video conference provider 310 may be notified that the new meeting is a follow-up meeting, which may cause the video conference provider 310 to maintain a relationship between the video conference and the follow-up meeting. It may do so by providing access to a recording for the on-going video conference to the other participants once the recording is available, which may occur after the on-going video conference concludes, e.g. by sending an email or adding the recording to meeting information associated with the follow-up meeting. The invited participants may be able to access the recording via their video conferencing application, such as by selecting an option to view details about the follow-up meeting and being provided with a link to the recording in addition to the time for the follow-up meeting, etc.

To provide the meeting invitation, the video conferencing application 350 may directly interact with one or more participants' electronic calendars to add the meeting to the respective calendar. In some examples, the video conferencing application 350 may communicate the meeting invitation to the video conferencing applications executing on other participants' client devices with the option to add the meeting to their respective calendar (which may involve the participant being requested to login to, or provide user credentials for, their electronic calendar). In some examples, the meeting invitation may be communicated via a separate application. For example, the video conferencing application may generate a meeting invitation according to a format for an email or calendar application that may be transmitted by email, text messaging to one or more telephony devices, etc. In some examples, the meeting invitation may be inserted into a chat window within the GUI 400 (as will be discussed in more detail with respect to FIG. 12).

Once the meeting has been communicated to the selected participants, the user may later modify the scheduled meeting or cancel it. Modifying the meeting may involve returning to the step of requesting availability or otherwise accessing the calendar GUI 1100 shown in FIG. 10 to select a new time for the meeting. Alternatively, the user may select a new participant to add to the group, or to remove a participant from the group. If the meeting has already been scheduled, adding a participant may cause the video conferencing application to immediately provide the meeting invitation to the new participant. Alternatively, if a participant is removed after the meeting has been scheduled, the video conferencing application 350 may remove the meeting from the participant's calendar, or provide a cancelation notice using a similar mechanism as may be used to provide a meeting invitation, as discussed above. Similarly, if the user cancels the meeting, it may be removed from the participants' calendars using a similar process, such as by directly accessing their respective calendars or by providing a cancelation notice.

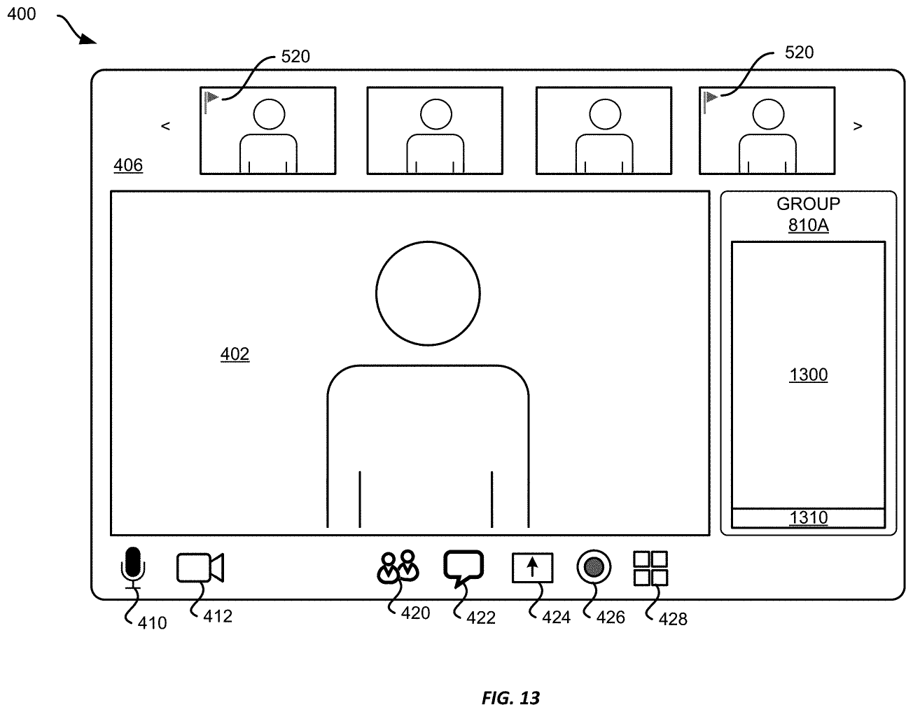

Referring now to FIG. 13, FIG. 13 illustrates the GUI 400 in which the GUI 400 has expanded to include a chat window 1300 and text entry window 1310 associated with one of the follow-up groups 810a. The chat window 1300 can be used to view messages from other members of the group, while the text entry window 1310 is used to type messages, send reactions, etc. to the group. To access the chat window, the user may select a group 810a in the GUI 400 and then select control 422 to send text messages to the group. And while a chat window is shown for only one group 810a, any number of chat windows for various groups may be displayed in different examples.

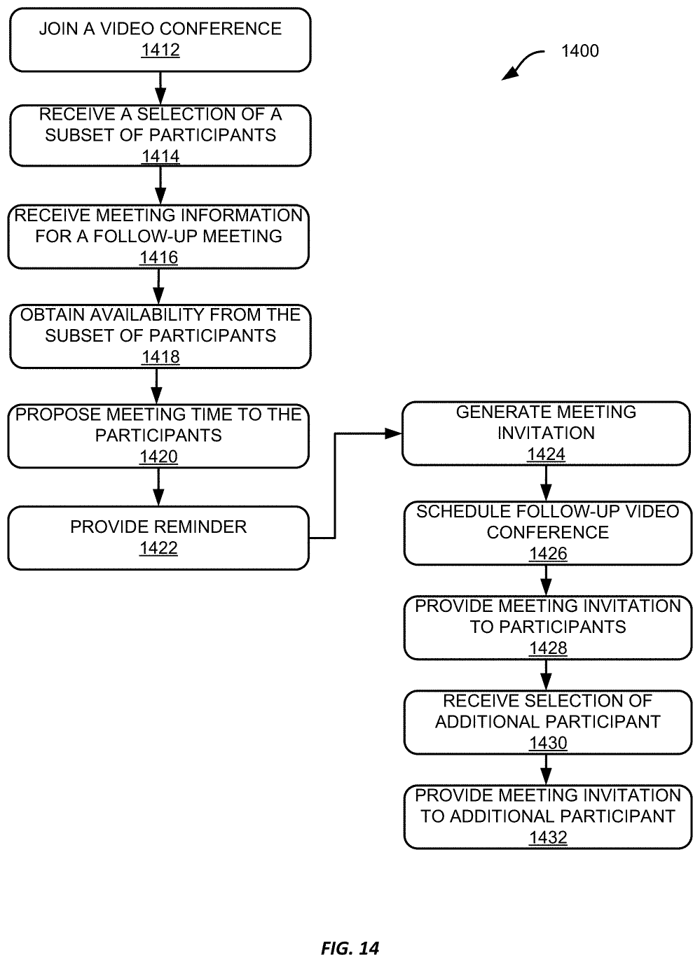

Referring now to FIG. 14, FIG. 14 shows an example method for in-meeting follow-up schedulers for video conferences. The method will be described with respect to the system shown in FIGS. 3A-3B and the GUIs 400, 500, 600 shown in FIGS. 4-13. However, it should be appreciated that any suitable system or GUI according to this disclosure may be employed, including the systems 100, 200 shown in FIGS. 1 and 2.

At block 1412, the user of the client device 330 uses the video conferencing application 350 to join a video conference hosted by the video conference provider 310, generally as described above with respect to FIGS. 1-3A and 3B.

At block 1414, the video conferencing application 350 receives a selection of a subset of participants in the video conference during the video conference, generally as discussed above with respect to FIG. 5 or 6. For example, the user may use a context-sensitive menu 510, 610 to select each participant of interest for a follow-up meeting. In some examples, the video conferencing application 350 may provide a list of participants in the video conference, and the user may interact with the list of participants to select the subset of participants.

At block 1416, the video conferencing application 350, during the video conference, receives meeting information associated with a follow-up meeting. For example, the user may provide a meeting time and subject for the follow-up meeting. The meeting time may include a date and a start time. In some examples, the meeting time may also include a duration or an end time. Other meeting information may be provided as well, such as an agenda, one or more attachments, links to relevant information, etc.

At block 1418, the video conferencing application 350 may obtain availability from the subset of participants. To obtain their availability, the video conferencing application 350 may access one or more electronic calendars associated with one or more participants. Alternatively, the video conferencing application 350 may send a request to one or more participants to provide their availability. For example, the video conferencing applications executed by the respective participants may display an indication to provide calendar availability. In some examples, the user may use a chat window within the video conferencing application 350 to request the other participants provide their availability for a follow-up meeting. After receiving availability from one or more of the participants, the video conferencing application 350 may display the availability within a GUI 1100, such as is shown in FIG. 11.

At block 1420, the video conferencing application 350 may propose a meeting time to the participants. For example, the user may enter meeting information, as described above with respect to block 1416, such as by interacting with a GUI 1100 for the calendar and select one or more time blocks for a follow-up meeting. The selected time block(s) may then be provided to the other participants and presented in their respective GUIs. The participants may then select one or more time blocks, which responses are then received by the video conferencing application 350 and presented to the user, such as within the calendar GUI 1100.

At block 1422, the video conferencing application 350 may provide a reminder to the user about scheduling the follow-up meeting. As discussed above with respect to FIG. 12, a user may be distracted before they schedule the follow-up meeting or may have to immediately join another meeting after the current one concludes. Or they may simply select an option in the video conferencing application 350 to be reminded about scheduling the follow-up meeting at a later time. To accommodate such scenarios, the video conferencing application 350 may provide a reminder to the user to schedule the follow-up meeting. If the user has requested a reminder, the video conferencing application 350 may wait until the selected time or for the selected duration to elapse before providing the reminder. Alternatively, it may determine that, after a predetermined amount of time has elapsed after a meeting ends, a reminder about the follow-up meeting should be provided to the user. As discussed above, the reminder may be any suitable notification, such as an email message, a text or chat message, a pop-up window, a SMS notification sent to their smartphone, etc.

At block 1424, the video conferencing application 350 generates a meeting invitation, generally as described above with respect to FIG. 12. The meeting invitation may be generated within one or more of the participants' electronic calendars, by generating an invitation using a third-party application (e.g., Microsoft Outlook), by generating a meeting file according to a format for an electronic calendar, etc. Meeting information, such as the subject of the meeting, the meeting times (start and end, or start and duration), a meeting identifier and passcode from the video conference provider, one or more attachments, an agenda, etc. may be included in the meeting invitation. In addition, in some examples, the meeting invitation may include an association between the follow-up meeting and the then-current video conference. For example, a link to a recording of the video conference or to materials reviewed during the video conference may be included in the meeting invitation.

A meeting invitation may be generated by creating a new meeting within electronic calendars associated with one or more participants, or a link to the follow-up meeting may be communicated to the participants via the video conferencing application. Adding the meeting to the electronic calendars maybe performed without requiring action by the respective participant, though in some cases, the participant may be requested to confirm the meeting before it is added. For example, the meeting information may be provided to each participant and presented in their respective GUIs with an option to “add to calendar.” By selecting “add to calendar,” the meeting may be added to the participant's electronic calendar. Such an example may involve explicit permission to modify the participant's electronic calendar.

Rather than adding the meeting to one or more electronic calendars, the video conferencing application may create a meeting invitation using a third party application or by creating a file according to a file format for an electronic calendar. For example, the video conferencing application may generate a meeting invitation according to a Microsoft Outlook format. The invitation may be generated by the video conferencing application itself or by communicating with a third-party software application, such as Microsoft Outlook, which may create the invitation based on information received from the video conferencing application 350.

In some examples, participants may join the video conference using a telephony device, such as a smartphone, that is capable of receiving text messages, e.g., short message service (“SMS”) or similar messages. For such participants, the video conferencing application 350 may communicate with the video conference provider 310 to provide a text message to each such telephony device including a URL for the meeting invitation or to the meeting itself. Similarly, the video conferencing application 350 may use its chat functionality to provide a link to the meeting in a chat window associated with the participant.

It should be appreciated that in some examples, the meeting invitation may include information received from the video conference provider 310. Thus, the invitation may not be created, or may not be fully completed, until after block 1424 (described in more detail below) is performed.

At block 1426, the video conferencing application 350 schedules the follow-up meeting with the video conference provider 310. To schedule the follow-up meeting, the video conferencing application 350 provides the time for the meeting and either a duration or and ending time for the meeting. In this example, the video conferencing application 350 also identifies each of the participants invited to the follow-up meeting, such as by providing email addresses, usernames, etc. Though in some examples, the video conferencing application 350 may only identify the organizer of the meeting, who may be designated as the “host” of the meeting.

In response, the video conference provider 310 may provide information about the meeting, such as a meeting identifier and passcode, which may be used to access the meeting at the scheduled time. In some examples, the video conference provider may instead (or also) provide a URL to access the meeting at the scheduled time.

In some examples, the video conference provider 310 may also associate the follow-up video conference with the originating video conference. For example, the video conferencing application 350 may identify the meeting as a follow-up video conference when it schedules it with the video conference provider 310. The video conference provider 310 may then store an association between the two meetings, which may allow users accessing the follow-up meeting to also access information associated with the original meeting, such as the meeting recording, chat messages exchanged during the original meeting, attachments shared during the original meeting, etc. This may provide the participants some refreshed context about the original meeting before they join the follow-up meeting.

At block 1428, the video conferencing application 350 provides a meeting invitation to each participant of the subset of participants. In this example, the video conferencing application 350 adds the meeting to each participant's electronic calendar without requiring action from the respective participants, such as described above with respect to block 1422. However, in some examples the meeting invitation may be sent via the video conference provider 310, an email application or may be communicated through the video conferencing application 350, such as sending it as an attachment via a chat window to the other participants in the subset of participants. Alternatively, the video conferencing application 350 may communicate the meeting information to the video conferencing application executing at one or more of the participants' client device, which then generate a meeting in the respective participant's electronic calendar.

At block 1430, the video conferencing application 350 receives a selection of an additional participant, generally as discussed above with respect to block 1414.

At block 1432, the video conferencing application 350 creates and provides a meeting invitation to the additional participant, generally as discussed above with respect to blocks 1424 and 1428. Thus, as new participants are added to the subset, the video conferencing application 350 automatically extends the meeting invitation to the newly added participant. Similarly, if a participant is removed from the subset, the video conference application 350 may send a cancelation notice to the participant, or it may remove the meeting from the participant's electronic calendar.

It should be appreciated that example methods, such as the method 1400 discussed above, may be performed multiple times in parallel or in series, such as if multiple groups of participants are created as discussed above with respect to FIGS. 4-12. For example, the method may be executed for each group of participants that are created within the video conference. Further, the method 1400 may be executed at multiple different client devices. For example, if one client device creates one group of participants and a different client device creates another group of participants, each may execute method 1400 to schedule the follow-up meeting with the respective groups of participants. And while the blocks of the method 1400 have been discussed in a particular order, different orders are possible. For example, as discussed above, block 1424 may happen after block 1426, or some aspects of block 1424 may occur before block 1426, while others may occur after block 1426. Further, aspects of block 1424 may be combined with aspects of block 1428, or block 1428 may be entirely merged with the functionality of block 1424 in some examples. Similarly, the functionality of block 1422 may occur at any time after block 1414 and before block 1428.

In some examples, one or more blocks discussed above may be omitted from the method 1400. For example, one or both of blocks 1418 and 1420 may be omitted. Instead, the organizer of the follow-up meeting may simply establish a meeting time without requesting availability or proposing the meeting time to the other participants. Similarly the providing a reminder 1422 may be omitted if the video conferencing application 350 lacks such functionality or the user timely provides a meeting invitation to the selected participants.

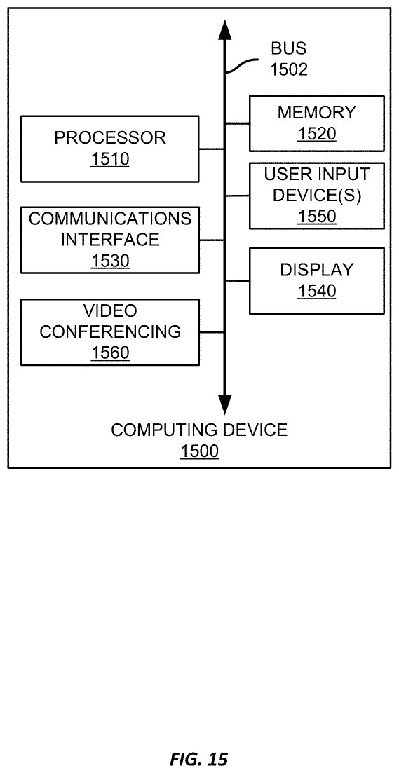

Referring now to FIG. 15, FIG. 15 shows an example computing device 1500 suitable for use in example systems or methods for dynamic context-sensitive virtual backgrounds for video conferences according to this disclosure. The example computing device 1500 includes a processor 1510 which is in communication with the memory 1520 and other components of the computing device 1500 using one or more communications buses 1502. The processor 1510 is configured to execute processor-executable instructions stored in the memory 1520 to perform one or more methods for in-meeting follow-up schedulers for video conferences according to different examples, such as part or all of the example method 1400 described above with respect to FIG. 14. The computing device 1500, in this example, also includes one or more user input devices 1550, such as a keyboard, mouse, touchscreen, microphone, etc., to accept user input. The computing device 1500 also includes a display 1540 to provide visual output to a user.

In addition, the computing device 1500 includes a video conferencing application 1560 to enable a user to join and participate in a video conference, such as a conventional meeting or webinar, by receiving multimedia streams from a video conference provider, sending multimedia streams to the video conference provider, joining and leaving breakout rooms, schedule follow-up meetings, etc. such as described throughout this disclosure, etc.

The computing device 1500 also includes a communications interface 1540. In some examples, the communications interface 1530 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

In addition to the examples discussed above, various aspects of the disclosure may be combined. For example, in a first aspect, a method includes joining, by a client device using a video conferencing application, a video conference hosted by a video conference provider; receiving, by the video conferencing application and during the video conference, a selection of a subset of participants in the video conference; receiving, by the video conferencing application, meeting information associated with a follow-up video conference; generating, by the video conferencing application, a meeting invitation to each participant of the subset of participants based on the received meeting information; scheduling, by the video conferencing application, the follow-up video conference with the video conference provider; and providing, by the video conferencing application, the meeting invitation to each participant of the subset of participants.

In a second aspect, a method according to the first aspect also includes, wherein providing the meeting invitation comprises, for at least one participant of the subset of participants, accessing an electronic calendar associated with the respective participant; and generating a meeting within the electronic calendar based on the meeting information.

In a third aspect, a method according to the first or second aspect also includes, wherein a first participant is attending the video conference by a telephony device, and where providing the meeting invitation comprises generating and transmitting a text message to the first participant, the text message including at least a portion of the meeting information.

In a fourth aspect, a method according to the third aspect also includes wherein the text message includes a link to a meeting invitation.

In a fifth aspect, a method according to any of the first through fourth aspects also includes generating a relationship between the video conference and the follow-up video conference; and providing the relationship to each participant of the subset of participants.

In a sixth aspect, a method according to any of the first through fifth aspects also includes providing, during the meeting, a notification to each participant of the subset of participants indicating the follow-up video conference.

In a seventh aspect, a method according to any of the first through sixth aspects also includes, during the meeting and by the video conference application, providing one or more proposed meeting times to the selected one or more participants; and receiving respective selections of the one or more proposed meeting times from at least one of the selected one or more participants.

In an eighth aspect, a method according to any of the first through seventh aspects also includes, during the meeting and by the video conference application, creating a chat channel for the selected one or more participants, and providing a notification in the chat channel about the follow-up video conference.

In a ninth aspect, a method according to any of the first through eighth aspects also includes, during the meeting and by the video conference application, receiving a selection of a second subset of participants in the video conference; receiving second meeting information associated with a second follow-up video conference; generating a second meeting invitation to each participant of the second subset of participants based on the received second meeting information; scheduling the second follow-up video conference with the video conference provider; and providing the second meeting invitation to each participant of the second subset of participants.

In a tenth aspect, a method according to any of the first through ninth aspects also includes, after providing the meeting invitation to each participant of the subset of participants, adding a first participant to the subset; and providing the meeting invitation to the first participant.

In an eleventh aspect, a method according to any of the first through tenth aspects also includes requesting availability of one or more participants in the subset of participants; receiving the availability of the one or more participants; and presenting the availability of the one or more participants in a graphical user interface.

In a twelfth aspect, a method according to any of the first through eleventh aspects also includes receiving a selection of a second subset of participants in the video conference; receiving second meeting information associated with a second follow-up video conference; generating a second meeting invitation to each participant of the second subset of participants based on the received second meeting information; scheduling the second follow-up video conference with the video conference provider; and providing the second meeting invitation to each participant of the second subset of participants.

In a thirteenth aspect, a method according to the twelfth aspect also includes create a first chat channel for the subset of participants, creating a second chat channel for the second subset of participants, providing a notification in the first chat channel about the follow-up video conference; and providing a second notification in the second chat channel about the second follow-up video conference.

In a fourteenth aspect, a client device includes a communications interface; a non-transitory computer-readable medium; and one or more processors communicatively coupled to the communications interface and the non-transitory computer-readable medium, the one or more processors configured to execute processor-executable instructions stored in the non-transitory computer-readable medium to join, by a video conferencing application, a video conference hosted by a video conference provider; receive, by the video conferencing application and during the video conference, a selection of a subset of participants in the video conference; receive, by the video conferencing application, meeting information associated with a follow-up video conference; generate, by the video conferencing application, a meeting invitation to each participant of the subset of participants based on the received meeting information; schedule, by the video conferencing application, the follow-up video conference with the video conference provider; and provide, by the video conferencing application, the meeting invitation to each participant of the subset of participants.

In a fifteenth aspect, a client device according to the fourteenth aspect also includes, wherein the one or more processors configured to execute further processor-executable instructions stored in the non-transitory computer-readable medium to access an electronic calendar associated with the respective participant; and generate a meeting within the electronic calendar based on the meeting information.

In a sixteenth aspect, a client device according to the fourteenth or fifteenth aspect also includes, wherein the one or more processors configured to execute further processor-executable instructions stored in the non-transitory computer-readable medium to, wherein a first participant is attending the video conference by a telephony device, and generate and transmit a text message to the first participant, the text message including at least a portion of the meeting information.

In a seventeenth aspect, a client device according to the sixteenth aspect also includes wherein the text message includes a link to a meeting invitation.

In an eighteenth aspect, a client device according to any of the fourteenth through seventeenth aspects also includes, wherein the one or more processors configured to execute further processor-executable instructions stored in the non-transitory computer-readable medium to generate a relationship between the video conference and the follow-up video conference; and provide the relationship to each participant of the subset of participants.

In a nineteenth aspect, a client device according to any of the fourteenth through eighteenth aspects also includes, wherein the one or more processors configured to execute further processor-executable instructions stored in the non-transitory computer-readable medium to provide, during the meeting, a notification to each participant of the subset of participants indicating the follow-up video conference.

In a twentieth aspect, a client device according to any of the fourteenth through nineteenth aspects also includes, wherein the one or more processors configured to execute further processor-executable instructions stored in the non-transitory computer-readable medium to, during the meeting, provide one or more proposed meeting times to the selected one or more participants; and receive respective selections of the one or more proposed meeting times from at least one of the selected one or more participants.

In a twenty-first aspect, a client device according to any of the fourteenth through twentieth aspects also includes, wherein the one or more processors configured to execute further processor-executable instructions stored in the non-transitory computer-readable medium to, during the meeting, create a chat channel for the selected one or more participants, and provide a notification in the chat channel about the follow-up video conference.

In a twenty-second aspect, a client device according to any of the fourteenth through twenty-first aspects also includes, wherein the one or more processors configured to execute further processor-executable instructions stored in the non-transitory computer-readable medium to, during the meeting, receive a selection of a second subset of participants in the video conference; receive second meeting information associated with a second follow-up video conference; generate a second meeting invitation to each participant of the second subset of participants based on the received second meeting information; schedule the second follow-up video conference with the video conference provider; and provide the second meeting invitation to each participant of the second subset of participants.

In a twenty-third aspect, a client device according to any of the fourteenth through twenty-second aspects also includes, wherein the one or more processors configured to execute further processor-executable instructions stored in the non-transitory computer-readable medium to, after providing the meeting invitation to each participant of the subset of participants, add a first participant to the subset; and provide the meeting invitation to the first participant.

In a twenty-fourth aspect, a client device according to any of the fourteenth through twenty-third aspects also includes, wherein the one or more processors configured to execute further processor-executable instructions stored in the non-transitory computer-readable medium to request availability of one or more participants in the subset of participants; receive the availability of the one or more participants; and present the availability of the one or more participants in a graphical user interface.

In a twenty-fifth aspect, a client device according to any one of the fourteenth through twenty-fourth aspects also includes, wherein the one or more processors configured to execute further processor-executable instructions stored in the non-transitory computer-readable medium to receive a selection of a second subset of participants in the video conference; receive second meeting information associated with a second follow-up video conference; generate a second meeting invitation to each participant of the second subset of participants based on the received second meeting information; schedule the second follow-up video conference with the video conference provider; and provide the second meeting invitation to each participant of the second subset of participants.

In a twenty-sixth aspect, a client device according to the twenty-fifth aspect also includes, wherein the one or more processors configured to execute further processor-executable instructions stored in the non-transitory computer-readable medium to create a first chat channel for the subset of participants, create a second chat channel for the second subset of participants, provide a notification in the first chat channel about the follow-up video conference; and provide a second notification in the second chat channel about the second follow-up video conference.

In a twenty-seventh aspect, a non-transitory computer-readable medium comprises processor-executable instructions configured to cause one or more processors to join, by a video conferencing application, a video conference hosted by a video conference provider; receive, by the video conferencing application and during the video conference, a selection of a subset of participants in the video conference; receive, by the video conferencing application, meeting information associated with a follow-up video conference; generate, by the video conferencing application, a meeting invitation to each participant of the subset of participants based on the received meeting information; schedule, by the video conferencing application, the follow-up video conference with the video conference provider; and provide, by the video conferencing application, the meeting invitation to each participant of the subset of participants.

In a twenty-eighth aspect, a non-transitory computer-readable medium according to the twenty-seventh aspect also includes processor-executable instructions configured to cause one or more processors to access an electronic calendar associated with the respective participant; and generate a meeting within the electronic calendar based on the meeting information.

In a twenty-ninth aspect, a non-transitory computer-readable medium according to the twenty-seventh or twenty-eighth aspects also includes processor-executable instructions configured to cause one or more processors to, wherein a first participant is attending the video conference by a telephony device, and generate and transmit a text message to the first participant, the text message including at least a portion of the meeting information.

In a thirtieth aspect, a non-transitory computer-readable medium according to the twenty-ninth aspect also includes wherein the text message includes a link to a meeting invitation.

In a thirty-first aspect, a non-transitory computer-readable medium according to any of the twenty-seventh through thirtieth aspects also includes processor-executable instructions configured to cause one or more processors to generate a relationship between the video conference and the follow-up video conference; and provide the relationship to each participant of the subset of participants.

In a thirty-second aspect, a non-transitory computer-readable medium according to any of the twenty-seventh through thirty-first aspects also includes processor-executable instructions configured to cause one or more processors to provide, during the meeting, a notification to each participant of the subset of participants indicating the follow-up video conference.

In a thirty-third aspect, a non-transitory computer-readable medium according to any of the twenty-seventh through thirty-second aspects also includes processor-executable instructions configured to cause one or more processors to, during the meeting, provide one or more proposed meeting times to the selected one or more participants; and receive respective selections of the one or more proposed meeting times from at least one of the selected one or more participants.

In a thirty-fourth aspect, a non-transitory computer-readable medium according to any of the twenty-seventh through thirty-third aspects also includes processor-executable instructions configured to cause one or more processors to, during the meeting, create a chat channel for the selected one or more participants, and provide a notification in the chat channel about the follow-up video conference.

In a thirty-fifth aspect, a non-transitory computer-readable medium according to any of the twenty-seventh through thirty-fourth aspects also includes processor-executable instructions configured to cause one or more processors to, during the meeting, receive a selection of a second subset of participants in the video conference; receive second meeting information associated with a second follow-up video conference; generate a second meeting invitation to each participant of the second subset of participants based on the received second meeting information; schedule the second follow-up video conference with the video conference provider; and provide the second meeting invitation to each participant of the second subset of participants.

In a thirty-sixth aspect, a non-transitory computer-readable medium according to any of the twenty-seventh through thirty-fifth aspects also includes processor-executable instructions configured to cause one or more processors to, after providing the meeting invitation to each participant of the subset of participants, add a first participant to the subset; and provide the meeting invitation to the first participant.

In a thirty-seventh aspect, a non-transitory computer-readable medium according to any of the twenty-seventh through thirty-sixth aspects also includes processor-executable instructions configured to cause one or more processors to request availability of one or more participants in the subset of participants; receiving the availability of the one or more participants; and presenting the availability of the one or more participants in a graphical user interface.

In a thirty-eighth aspect, a non-transitory computer-readable medium according to any of the twenty-seventh through thirty-seventh aspects also includes processor-executable instructions configured to cause one or more processors to receive a selection of a second subset of participants in the video conference; receive second meeting information associated with a second follow-up video conference; generate a second meeting invitation to each participant of the second subset of participants based on the received second meeting information; schedule the second follow-up video conference with the video conference provider; and provide the second meeting invitation to each participant of the second subset of participants.

In a thirty-ninth aspect, a non-transitory computer-readable medium according to the thirty-eighth aspect also includes processor-executable instructions configured to cause one or more processors to create a first chat channel for the subset of participants, create a second chat channel for the second subset of participants, provide a notification in the first chat channel about the follow-up video conference; and provide a second notification in the second chat channel about the second follow-up video conference.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
joining, by a client device using a video conferencing application, a video conference hosted by a video conference provider;
receiving, during the video conference and by the video conferencing application, a selection of a subset of participants in the video conference;
receiving, using the video conferencing application, meeting information associated with a follow-up video conference;
generating, using the video conferencing application, a meeting invitation to each participant of the subset of participants based on the received meeting information;
scheduling, using the video conferencing application, the follow-up video conference with the video conference provider; and
providing, using the video conferencing application, the meeting invitation to each participant of the subset of participants.

2. The method of claim 1, wherein providing the meeting invitation comprises, for at least one participant of the subset of participants:
accessing an electronic calendar associated with the respective participant; and
generating a meeting within the electronic calendar based on the meeting information.

3. The method of claim 1, wherein a first participant is attending the video conference by a telephony device, and where providing the meeting invitation comprises generating and transmitting a text message to the first participant, the text message including at least a portion of the meeting information.

4. The method of claim 3, wherein the text message includes a link to a meeting invitation.

5. The method of claim 1, further comprising:
generating a relationship between the video conference and the follow-up video conference; and
providing the relationship to each participant of the subset of participants.

6. The method of claim 1, further comprising providing, during the meeting, a notification to each participant of the subset of participants indicating the follow-up video conference.

7. The method of claim 1, further comprising, during the meeting and by the video conference application:
providing one or more proposed meeting times to the subset of participants; and
receiving respective selections of the one or more proposed meeting times from at least one participant of the subset of participants.

8. The method of claim 1, further comprising, during the meeting and by the video conference application, creating a chat channel for the subset of participants, and providing a notification in the chat channel about the follow-up video conference.

9. The method of claim 1, further comprising, during the meeting and by the video conference application:
receiving a selection of a second subset of participants in the video conference;
receiving second meeting information associated with a second follow-up video conference;
generating a second meeting invitation to each participant of the second subset of participants based on the received second meeting information;
scheduling the second follow-up video conference with the video conference provider; and
providing the second meeting invitation to each participant of the second subset of participants.

10. A client device comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
join, using a video conferencing application, a video conference hosted by a video conference provider;
receive, using the video conferencing application and during the video conference, a selection of a subset of participants in the video conference;
receive, using the video conferencing application, meeting information associated with a follow-up video conference;
generate, using the video conferencing application, a meeting invitation to each participant of the subset of participants based on the received meeting information;
schedule, using the video conferencing application, the follow-up video conference with the video conference provider; and
provide, using the video conferencing application, the meeting invitation to each participant of the subset of participants.

11. The client device of claim 10, wherein the one or more processors are configured to execute further processor-executable instructions stored in the non-transitory computer-readable medium to, for at least one participant of the subset of participants:
access an electronic calendar associated with the respective participant; and
generate a meeting within the electronic calendar based on the meeting information.

12. The client device of claim 10, wherein a first participant is attending the video conference by a telephony device, and wherein the one or more processors are configured to execute further processor-executable instructions stored in the non-transitory computer-readable medium to generate and transmit a text message to the first participant, the text message including at least a portion of the meeting information.

13. The client device of claim 12, wherein the text message includes a link to a meeting invitation.

14. The client device of claim 10, wherein the one or more processors are configured to execute further processor-executable instructions stored in the non-transitory computer-readable medium to, after providing the meeting invitation to each participant of the subset of participants:
add a first participant to the subset; and
provide the meeting invitation to the first participant.

15. The client device of claim 10, wherein the one or more processors are configured to execute further processor-executable instructions stored in the non-transitory computer-readable medium to:
request availability of one or more participants in the subset of participants;
receive the availability of the one or more participants; and
present the availability of the one or more participants in a graphical user interface.

16. A non-transitory computer-readable medium comprising processor-executable instructions stored in the non-transitory computer-readable medium to cause one or more processors to:
join, using a video conferencing application, a video conference hosted by a video conference provider;
receive, using the video conferencing application and during the video conference, a selection of a subset of participants in the video conference;
receive, using the video conferencing application, meeting information associated with a follow-up video conference;
generate, using the video conferencing application, a meeting invitation to each participant of the subset of participants based on the received meeting information;
schedule, using the video conferencing application, the follow-up video conference with the video conference provider; and
provide, using the video conferencing application, the meeting invitation to each participant of the subset of participants.

17. The non-transitory computer-readable medium of claim 16, further comprising processor-executable instructions configured to cause the one or more processors to:
receive a selection of a second subset of participants in the video conference;
receive second meeting information associated with a second follow-up video conference;
generate a second meeting invitation to each participant of the second subset of participants based on the received second meeting information;
schedule the second follow-up video conference with the video conference provider; and
provide the second meeting invitation to each participant of the second subset of participants.

18. The non-transitory computer-readable medium of claim 17, further comprising processor-executable instructions configured to cause the one or more processors to, during the meeting:
create a first chat channel for the subset of participants,
create a second chat channel for the second subset of participants,
provide a notification in the first chat channel about the follow-up video conference; and
provide a second notification in the second chat channel about the second follow-up video conference.

19. The non-transitory computer-readable medium of claim 16, further comprising processor-executable instructions configured to cause the one or more processors to:
provide one or more proposed meeting times to the subset of participants; and
receive respective selections of the one or more proposed meeting times from at least one participant of the subset of participants.

20. The non-transitory computer-readable medium of claim 16, further comprising processor-executable instructions configured to cause the one or more processors to:
request availability of one or more participants in the subset of participants;
receive the availability of the one or more participants; and
present the availability of the one or more participants in a graphical user interface.
